(19) United States
(12) Patent Application Publication
(10) Pub. No.: US 2015/0344988 A1
(43) Pub. Date: Dec. 3, 2015

(54) PROCESS FOR REDUCING OF LEACHABLE FLUORIDES AND CONTROLLING PH OF ALUMINUM WASTE PRODUCTS

(71) Applicant: RIO TINTO ALCAN INTERNATIONAL LIMITED, Montréal (CA)

(72) Inventors: Ghislain HAMEL, Jonquière (CA); Raymond BREAULT, Larouche (CA); Alain MARCOUX, Jonquière (CA)

(73) Assignee: RIO TINTO ALCAN INTERNATIONAL LIMITED, Montréal (CA)

(21) Appl. No.: 14/653,638

(22) PCT Filed: Dec. 19, 2013
(86) PCT No.: PCT/CA2013/050990

§ 371 Date: Jun. 18, 2015

Related U.S. Application Data
(60) Provisional application No. 61/740,589, filed on Dec. 21, 2012.

(51) Int. Cl. C22B 7/00; C22B 21/00; B09B 3/00

(52) U.S. Cl. CPC C22B 7/008; B09B 3/00; C22B 21/0023

(57) ABSTRACT

The present disclosure provides processes for recycling spent pot lining carbon by-products (SPLCB) obtained from a caustic leach process. The process provides treating spent pot lining (SPL) or SPLCB with Ca/P-containing stabilizing agents.

### CROSS-REFERENCE TO RELATED APPLICATIONS

This application claims priority on U.S. provisional patent application 61/740,589 filed on Dec. 21, 2012 and herewith incorporated in its entirety.

### TECHNOLOGICAL FIELD

The present disclosure relates to processes for obtaining aluminum waste product, especially derived from spent pot lining, having a reduced amount of leachable fluorides. The present disclosure also relates to processes for obtaining aluminum waste product, especially derived from spent pot lining, having a pH value allowing safe disposal.

### BACKGROUND

Aluminum can be produced by dissolving alumina at high temperature in molten cryolite in electrolytic cells (also referred to as pots) provided with electrically conductive carbon linings, and electrolyzing the molten solution by passing an electric current between carbon anodes dipping into the melt and the carbon linings acting as cathodes. Cells of this type may be used for considerable periods of time, e.g. up to ten years, and during this time the carbon lining material absorbs sodium fluoride and other contaminants. At the end of the operational lifetime of the cells, the linings are removed and broken up and have to be disposed. However, the spent lining material, which is composed of carbon, refractory material from insulating refractory bricks and cryolite, including fluorine, aluminum, sodium, calcium and silicon values, along with free and complexed cyanides, carbides and nitrides, is hazardous and must be treated with great caution.

The electrolytic cells for producing aluminum are typically of two types. The first is a pre-bake type, where the carbon-based anodes are first formed and then are baked under high temperature to maintain their shape without support in the cell. The second is the Soderberg cell where the anode material is semi-fluid and requires an open-ended box-like container to hold it in place.

The safe disposal of spent linings has for a long time presented a challenge to the industry. That challenge continues with ever stricter environmental standards. Thus, disposal residues are limited to very low concentrations of fluorides, e.g. TCLP (Toxicity Characteristic Leaching Procedure) leachable fluorides of less than 150 ppm.

It was previously shown that a caustic leach can be successfully used to recycle spent pot lining material (U.S. Pat. No. 5,470,559). It was also shown that submitting the spent pot lining to a first water leach prior to a second caustic leach, optionally in combination with a further repulping step or chemical activation step, can improve the overall process (U.S. Pat. No. 6,596,252). Other recycling methods have also been developed and can include a flotation step (CN Patent Serial Number 101811695 as well as CA Patent Applications Serial Number 2,588,929 and 2,631,092).

It would be desirable to be provided with a method for recycling spent pot lining material into a residue having a low quantity of leachable fluorides.

### BRIEF SUMMARY

In accordance with the present disclosure there is provided a process for treating spent pot lining carbon by-products (SPLCB) to reduce/limit their content in leachable fluorides and/or reduce their pH. Broadly, the process comprises treating, during a caustic leach, a spent pot lining (SPL) with Ca/P-containing stabilizing agents and/or treating, during a wash, a SPLCB with Ca/P-containing stabilizing agents to obtain SPLCB residues. In an embodiment, the ratio (w/w) between Ca/P-containing stabilizing agents and the initial weight of the SPL or the SPLCB is between about 0.2% w/w to about 20% w/w. In another embodiment, the Ca/P-containing stabilizing agents comprises a calcium phosphate (for example a calcium phosphate selected from the group consisting of Ca₃(PO₄)₂, Ca(H₂PO₄)₂, Ca(HPO₄)₂, Ca₂O₇P₂, Ca₅(PO₄)₃OH, Ca(HPO₃), Ca(PO₃)₂, Ca(H₂PO₂)₂₂, Ca₅(PO₄)₃OH) their hydrated forms and combinations thereof). In another embodiment, the Ca/P-containing stabilizing agents comprises a lime (for example a milk of lime) and phosphoric acid. In one embodiment, the process one or both of the treatment steps is(are) conducted on a filter(s) (for example a treatment filter or a washing filter). In another embodiment, one or both of the treatment step is(are) conducted in a reactor(s) (for example a treatment reactor or a washing reactor). In yet another embodiment, one treatment step is conducted on a filter whereas the other treatment step is conducted in a reactor. In some embodiments, the process can be designed so as to avoid the use of any surfactant for the production of the SPLCB residues.

### BRIEF DESCRIPTION OF THE DRAWINGS

Having thus generally described the nature of the invention, reference will now be made to the accompanying drawings, showing by way of illustration, a preferred embodiment thereof, and in which:

FIG. 1 is a flow chart illustrating embodiments of the process of converting spent pot lining into spent pot lining residues.

FIG. 2 is a flow diagram illustrating embodiments of the process of converting the spent pot lining into spent pot lining residues in the absence (A) or in the presence (B) of a preliminary washing step. S=filtered solid part of the slurry, L=filtered liquid part of the slurry.

FIG. 3 is a flow chart illustrating embodiments of the process of converting spent pot lining carbon by-products into spent pot lining carbon by-products residues.

FIG. 4 provides flow diagrams illustrating embodiments of the process of converting spent pot lining carbon by-products into a spent pot lining carbon by-products residues. (A) Flow diagram for a process where both the treatment step and the washing step are conducted directly on the filter. (B) Flow diagram for a process where the treatment step is conducted on the filter, but the washing step is conducted in a reactor. (C) Flow diagram for a process where the treatment step is conducted in a reactor, while the washing step is conducted on the filter. (D) Flow diagram where both the treatment and the washing steps are conducted in reactors. S=filtered solid part of the slurry, L=filtered liquid part of the slurry.

FIG. 5 is an illustrative process indicating how the different samples obtained in Example III were acquired. (1) Untreated and unwashed SPLCB slurry sample, (2) water washed SPLCB retentate sample prior to the milk of lime treatment, (3) milk of lime-treated SPLCB retentate sample as well as (4) milk of lime-treated SPLCB wet cake sample after good mixing.

### DETAILED DESCRIPTION

In accordance with the present disclosure, there is provided processes for converting spent pot lining, spent pot lining carbon by-products (preferably obtained via the treatment of spent pot lining with a caustic leaching) into spent pot lining carbon by-products residues. In order to convert spent pot lining into spent pot lining by-products residues, the spent pot lining is submitted to a caustic leach and is optionally treated after the caustic leach. In the present disclosure, it is shown that including a treatment with Ca/P-containing stabilizing agents either during the caustic leach or during a subsequent treatment step can lead to a reduction in the leachable fluoride content of the resulting residues and/or lower the pH of the resulting residues. In addition, the processes described herein do not require the use of a surfactant (e.g. surfactant-free processes).

As it will be shown and described below, it was found that, after conventional leaching with caustic (and optionally washing with water), the spent pot lining carbon by-products did not satisfy the TCLP norm of a maximum of 150 ppm leachable fluorides. It was found that leachable fluorides contained in spent pot lining carbon by-products, before treatment with Ca/P-containing stabilizing agents, can be present in a solid form. In order to reduce the amount of leachable fluorides in the spent pot lining carbon by-products, a treatment with Ca/P-containing stabilizing agents was successfully used. The treatment with Ca/P-containing stabilizing agents can be undertaken during the caustic leach and/or after the caustic leach. Without wishing to be bound to theory, it is believed that a treatment with Ca/P-containing stabilizing agents did not appear to react directly with the leachable fluorides of the spent pot lining carbon by-products but rather stabilize them (as demonstrated in the toxicity characteristics leaching procedure (TCLP) testing).

It was also found that the addition of milk of lime can cause an increase in the pH (sometimes even above 12.5) of the spent pot lining carbon by-products residues. Without wishing to be bound to theory, it is believed that this increase is due to a reaction between the milk of lime with the spent pot lining carbon by-products residues causing the formation of caustic. As shown below, it was surprisingly found that further washing of the spent pot lining carbon by-products residues (either with water or with a solution containing Ca/P-containing stabilizing agents) allowed for a decrease as well as a stabilization of the pH spent pot lining carbon by-products residues.

The processes described herein refer to reduction of leachable fluorides levels of spent pot lining carbon by-products (SPLCB). The process described herein can be applied to any SPLCB that has been obtained from a caustic leaching of spent pot lining material.

### DEFINITIONS

Throughout this application, various terms are used and some of them are more precisely defined herein.

Calcium/Phosphate-containing stabilizing agent. As used herein, the term “calcium/phosphate-containing stabilizing agent” (or Ca/P-containing stabilizing agent) refers to an inorganic (optionally from mineral origin) compound or a combination of inorganic compounds containing calcium and phosphate and being capable of releasing calcium ions and phosphate groups in water for trapping fluorides (e.g., in some embodiments, in the form of a fluorapatite) in the solid fraction of a spent pot lining carbon by-products. One particularly advantageous Ca/P-containing stabilizing agent is a combination of lime (e.g., quicklime (CaO) as well as hydrated lime (Ca(OH)₂)) or a lime derivative and phosphoric acid. In some embodiments, a milk of lime solution (a saturated Ca(OH)₂ solution containing excess calcium hydroxide) can be used in the combination. Another Ca/P-containing stabilizing agent is calcium phosphate in its anhydride as well as its hydrated forms. Exemplary calcium phosphates include, but are not limited to, tricalcium phosphate (Ca₃(PO₄)₂), dicalcium phosphate (CaHPO₄, and in some embodiments dicalcium phosphate dihydrate Ca(HPO₄).2H₂O), Ca(H₂PO₄)₂ (as well as it monohydrate Ca(H₂PO₄)₂.H₂O), calcium pyrophosphate (Ca₂O₇P₂), Ca₅(PO₄)₃OH, Ca(HPO₃), Ca(PO₃)₂, Ca(H₂PO₂)₂, defluorinated or hydroxyapatite calcium phosphate (Ca₅(PO₄)₃OH) as well as any combinations thereof.

Filter. As used herein, the term “filter” refers to a mesh for retaining a solid portion of a slurry (e.g. retentate) and for removing the liquid portion of the slurry (e.g. filtrate). The “treatment filter” refers to a filter used during the caustic leach step. The “washing filter” refers to a filter used during the washing step. In some embodiments, the treatment filter is distinct from the washing filter. In other embodiments, the treatment filter and the washing filter are the same filter. The filter can be, for example, a vacuum filter or a pressure filter.

Reactor. As used herein, the term “reactor” refers to a container for receiving spent pot lining processed material. The spent pot lining processed material can be provided in a form of a slurry in the reactor or can be mixed with a solution in the reactor to provide a slurry. The “treatment reactor” refers to a reactor in which the treatment step is conducted. The “washing reactor” refers to a reactor in which the washing step is conducted. In some embodiments, the treatment reactor is distinct from the washing reactor. In other embodiments, the treatment reactor and the washing reactor is the same reactor.

Retentate. As used herein, the term retentate refers to the solid fraction of a filtered slurry which remains on the filter. Once a retentate is removed from the filter, it is usually referred to as a wet cake. By opposition, the term filtrate is used to refer to the liquid fraction obtained by filtering a slurry.

Spent pot lining (SPL). As used herein, the term “spent pot lining” (also referred to as spent pot material) refers to the material of an aluminum electrolytic cell. SPL are not limited to a specific type of electrolytic cell. In some embodiments, the spent pot lining material can be composed of carbon, refractory material from insulating refractory bricks and cryolite, including fluorine, aluminum, sodium, calcium and silicon values, along with free and complexed cyanides, carbides and/or nitrides. In an embodiment, the SPL has a substantial content of cryolite. The spent pot lining residue includes, but is not limited to, spent pot lining carbon by-products.

Spent pot lining carbon by-products (SPLCB). As used herein, the term “spent pot lining carbon by-products” refers broadly to a material obtained after a caustic leach of an SPL. SPLCB are not limited to carbon-containing by-products and can include cyanides as well as fluorides-containing by-products. As the content of SPL is subject to variations, the content of the SPLCB also varies. The term spent pot lining carbon by-products residue refers to the material obtained from spent pot lining carbon by-products which has been submitted to a treatment with Ca/P-containing stabilizing agents (either during or after the caustic leach).

Spent pot lining processed material. The term “spent pot lining processed material” refers broadly to any spent pot lining material which has been submitted to at least one a step leading to its disposal (for example treating, caustic leaching, washing). In the context of the present disclosure, the spent pot lining processed material includes SPL as well as SPLCB.

Slurry. As used herein, the term “slurry” refers to a solution containing spent pot lining processed material and water. The “treatment slurry” refers to a slurry submitted to a caustic leach step. In some embodiments, the “treatment” slurry comprises Ca/P-containing stabilizing agents and NaOH. The “washing slurry” refers to a slurry submitted to a washing step. In some embodiments, the washing slurry comprises Ca/P-containing stabilizing agents.

Toxicity characteristics leaching procedure (TCLP). As used herein, the term “toxicity characteristics leaching procedure” refers to an analytical method to simulate leaching.

Process for Obtaining Spent Pot Lining Carbon by-Products (SPLCB)

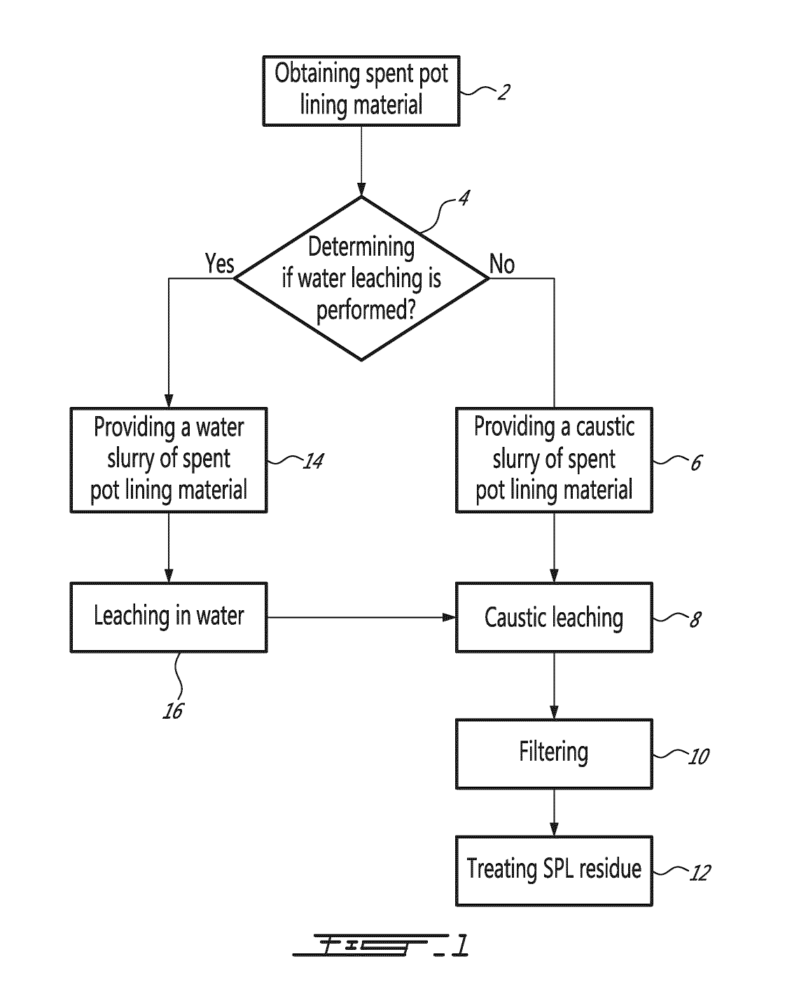

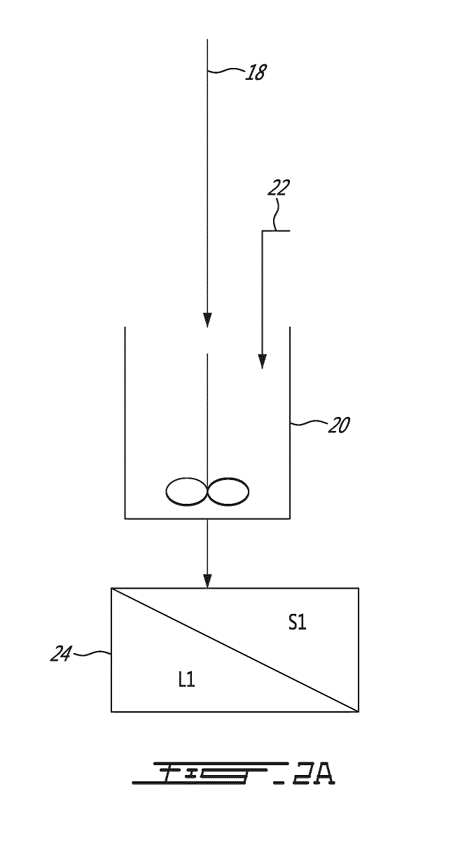

In order to provide spent pot lining carbon by-products, a caustic leaching of spent pot lining material is performed. In order to do so, and as shown in FIG. 1, a spent pot material is first obtained (2). Then, at step 4, it is determined whether an optional water leach (see below) should be conducted. If it is determined that no optional water leach is performed, then the spent pot lining is diluted to provide, in step 6, the caustic slurry for the caustic leach. The dilution ratio of the spent pot line material to leachate in the caustic leach is between 1:4 and 1:20 (based on the weight of the initial spent pot material). The dilution rate depends on the water soluble and caustic soluble fluorides present in the spent pot lining material, to generate a fluoride concentration of about 10 g/L as fluoride ions in the leachate.

The caustic slurry is then fed to a reactor to undertake the caustic leaching step 8. Optionally, this caustic leaching stage reactor is a line of cascade reactors, each having a high shear mixing pump. In this caustic leaching stage, the slurry is leached with about 20 to 50 g/L NaOH at a temperature of about 60 to 95° C. for a period of about 40 to 80 minutes. In some embodiments, the Ca/P-containing stabilizing agents are added to caustic slurry prior to the caustic leaching stage. When present at the caustic leaching stage, in an embodiment, the Ca/P-containing stabilizing agent are preferably added at a weight percentage between about 0.2% to about 20%, between about 0.5% to about 20%, between about 1.0% to about 20%, between about 2% to about 20% or between about 6% to about 20% when compared to the weight of the spent pot lining material that is submitted to the caustic leach. In another embodiment, the Ca/P-containing stabilizing agent can be added at a weight percentage between about 0.2% to about 12%, between about 0.5% to about 12%, between about 1.0% to about 12%, between about 2% to about 12% or between about 6% to about 12% when compared to the weight of the spent pot lining material that is submitted to the caustic leach. In still another embodiment, the Ca/P-containing stabilizing agent can be added at a weight percentage between about 0.2% to about 10%, between about 0.5% to about 10%, between about 1.0% to about 10%, between about 2% to about 10% or between about 6% to about 10% when compared to the weight of the spent pot lining material that is submitted to the caustic leach. In yet another embodiment, the Ca/P-containing stabilizing agent can be added at a weight percentage between about 0.2% to about 6%, between about 0.5% to about 6%, between about 1.0% to about 6% or between about 2% to about 6% when compared to the weight of the spent pot lining material that is submitted to the caustic leach. Following this caustic leaching step, the slurry is submitted to a filtering step 10 where the retentate is washed (in some embodiments, twice with water heated to about 90° C.). The SPL residue obtained can be further treated (step 12) as it will be discussed below.

When it is determined that, prior to the caustic leach, an optional water leach is required, the crushed pot lining is first diluted at step 14 at a ratio of about 1:3 to 1:8 (based on the initial weight of the spent pot material). The water leaching step 16 is conducted at a temperature of about 20 to 70° C. for a period of about 10 to 20 minutes. After this water leaching step, the resulting slurry (optionally filtered) is fed to the caustic leach reactor to perform the caustic leach (e.g. steps 8 to 12). In some embodiments, when the spent pot material has been optionally treated with water, the dilution ratio of the caustic leach step is from 1:4 to 1:12 (based on the weight of the initial spent pot lining material).

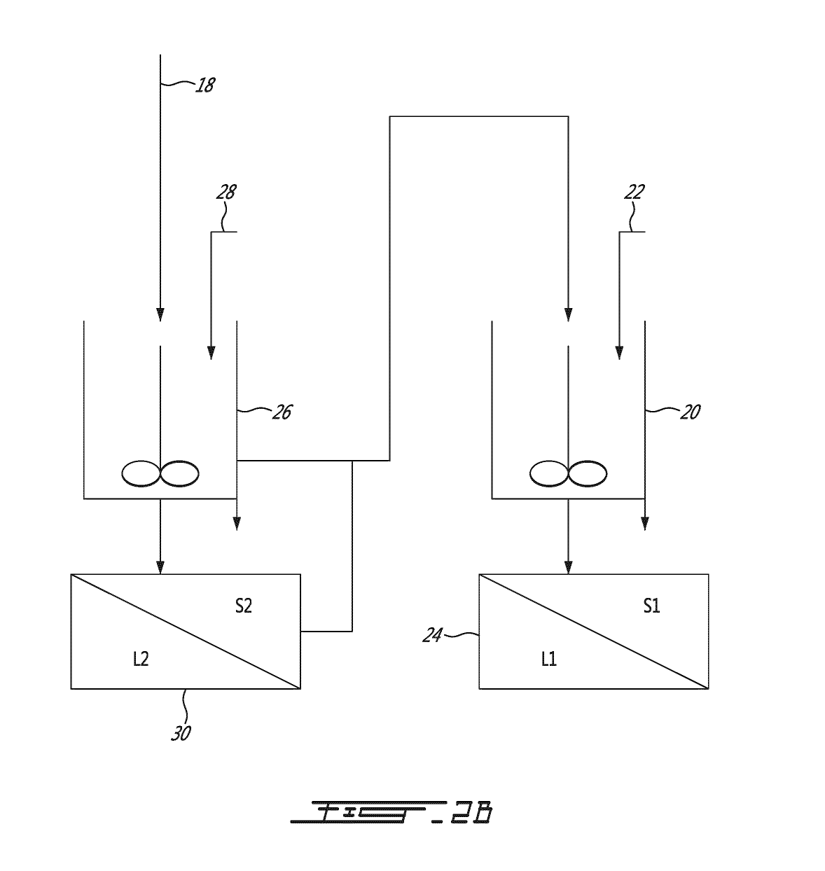

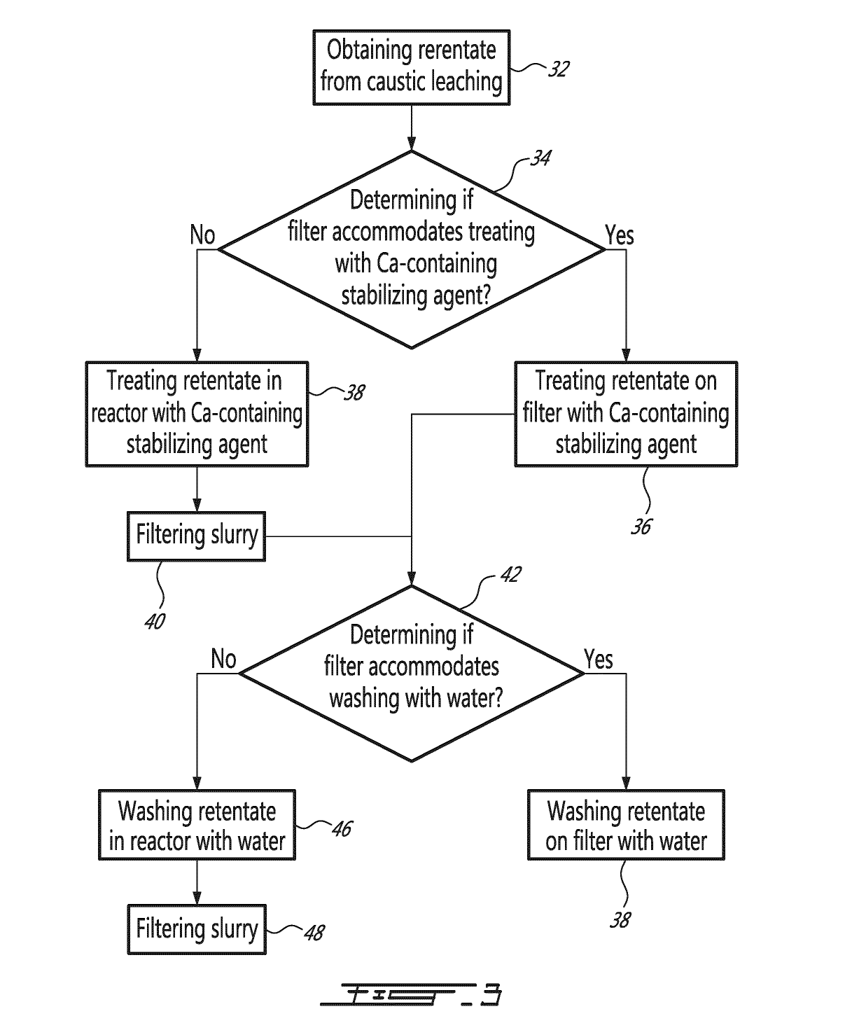

The process for obtaining SPLCB described above can be performed using a combination of reactor(s) and filter(s). As shown on FIG. 2A, the spent pot material 18 (obtained, for example by crushing/grinding spent pot lining material to a small particle size (e.g. about −65 to −28, preferably −48 when using Tyler mesh)) is added to the caustic leach reactor 20 in the form of a slurry. NaOH (optionally in combination with the Ca/P-containing stabilizing agent) 22 is added to the caustic leach reactor 20. The caustic leach reactor can be, for example, a baffled stirred tank equipped with high intensity agitation. Optionally, the reactor can be equipped with a high shear mixing pump which recirculates the bottoms from each tank onto the top of the reactor. Alternatively, or in combination, a line of serially connected caustic leach reactors can be used. Once the caustic leach step has been completed, the resulting slurry is fed to a filter 24 to provide a wet cake S1 (comprising SPL residues) which can be further treated as it will be explained below. The filtration step also provides a liquid fraction (or filtrate) L1 which can be recycled or submitted to further processing.

In embodiments, where it is determined that an optional water leach be performed prior to the caustic leach, and as shown on FIG. 2B, the spent pot lining 18 and water 28 are added to a water leach reactor 26. The water leach reactor 26 can be, for example, a baffled stirred tank equipped with high intensity agitation. Optionally, the reactor can be equipped with a high shear mixing pump which recirculates the bottoms from each tank onto the top of the reactor. Alternatively, or in combination, a line of serially connected water leach reactors can be used. Once the water leach step has been completed, the resulting slurry can be directly fed into the caustic leach reactor 20. Alternatively, the resulting slurry can be fed to a filter 30 to provide a wet cake S2 which is fed to the caustic leach reactor 20. The filtration step also provides a liquid fraction (filtrate) L2 which can be recycled or submitted to further processing. The repulped slurry or the wet cake S2 is submitted to a caustic leach in reactor 20 by the addition of NaOH 22 (optionally in combination with Ca/P-containing stabilizing agents). Once the caustic leach is completed, the resulting slurry can be fed to a filter 24 to provide a wet cake S1 (comprising SPL residues) which is going to be further treated as it will be explained below. The filtration step also provides a liquid portion (filtrate) L1 which can be recycled or submitted to further processing.

For some spent pot lining materials that are difficult to leach, the wet cake from the caustic leach can be subjected to a re-pulping step. In order to do so, the spent pot lining material residue from the filter is sent to a re-pulping vessel where the slurry is re-pulped in water for a period of time from about 10 to 20 minutes at a temperature of about 60° C., at a dilution ratio of 1:2 (based on the weight of the initial spent pot material). The obtained slurry is filtered and the resulting cake (e.g., retentate) is washed with water.

During leaching of the spent pot lining material, a continuous reprecipitation of sodium aluminum silicate compounds on the surface of the particles can be observed. These compounds tend to block the pores of the spent pot lining particles and stop the solubility of residual fluorides. They also tend to inhibit the reaction of caustic solution with cryolite trapped inside the pores. Accordingly, to assure an efficient leaching, it may be important to remove this coating in a continuous manner. An optional acid activation step has been found to remove this obstruction without significant process or economic penalty. The subsequent dilute caustic re-pulping can also be beneficial to react and dissolve the newly exposed residual fluorides from the spent pot lining material. The dilution ratio in this optional acid activation test is typically 1:2 by weight based on the initial spent pot lining material.

Process for Treating the Spent Pot Lining Carbon by-Products

The obtained SPL residues (S1 in FIGS. 2A and 2B) comprising the spent pot lining carbon by-products (SPLCB) are then submitted to a series of steps to reduce its leachable fluoride content as well as to stabilize (and in some embodiments lower) the pH of the resulting residue. In order to do so, the SPLCB can be submitted to a first treatment with Ca/P-containing stabilizing agents (to reduce the leachable fluoride content of the resulting residue) and then to a subsequent washing with water (to control the pH properties of the resulting residue).

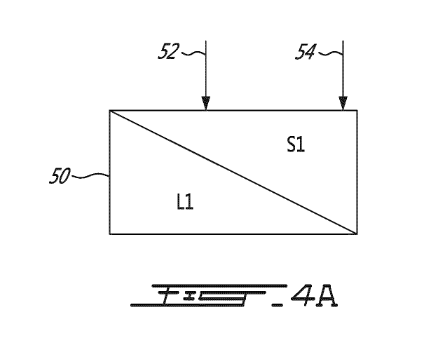

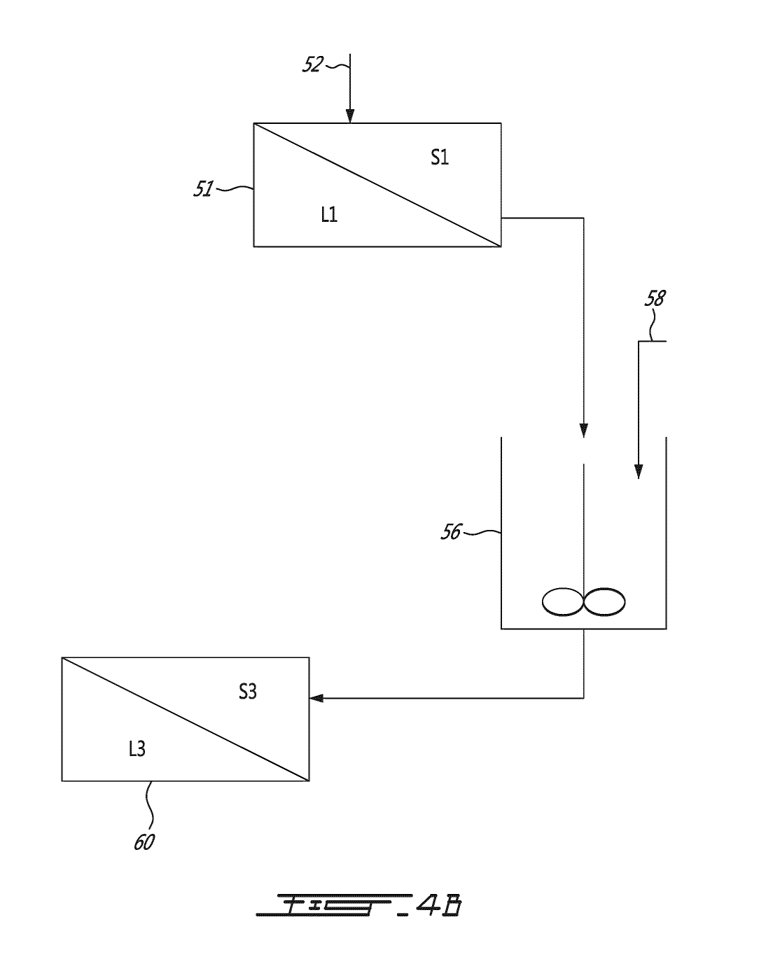

More specifically, as shown in FIG. 3, a retentate comprising the SPLCB is obtained in step 32. The wet cake of SPLCB is preferably obtained from a caustic leach of a SPL (obtained in step 12 from FIG. 1 for example). Then, at step 34, it is determined whether a filter (for example the one used to recuperate the wet cake comprising the SPLCB, as shown for filter 24 in FIGS. 2A and 2B) can be used to conduct a treatment step with Ca/P-containing stabilizing agents. If the filter can be used for this treatment step, the retentate is treated at step 36 directly on the filter with a solution comprising (or consisting essentially of) Ca/P-containing stabilizing agents. The treatment step 36 is preferably conducted at a temperature between about 0° C. and about 100° C. (in some embodiments, at a temperature between about 20° C. to about 95° C.). In some embodiments, the ratio (w/w) between Ca/P-containing stabilizing agents (provided in a solution or a powder form) and the initial weight of SPLCB is between about 0.2% to about 20%, between about 0.5% to about 20%, between about 1.0% to about 20%, between about 2% to about 20% or between about 6% to about 20%. In another embodiment, the ratio (w/w) between Ca/P-containing stabilizing agents and the initial weight of SPLCB is between about 0.2% to about 12%, between about 0.5% to about 12%, between about 1.0% to about 12%, between about 2% to about 12% or between about 6% to about 12%. In still another embodiment, the ratio (w/w) between Ca/P-containing stabilizing agents and the initial weight of SPLCB is between about 0.2% to about 10%, between about 0.5% to about 10%, between about 1.0% to about 10%, between about 2% to about 10% or between about 6% to about 10%. In yet another embodiment, the ratio (w/w) between Ca/P-containing stabilizing agents and the initial weight of SPLCB is between about 0.2% to about 6%, between about 0.5% to about 6%, between about 1.0% to about 6% or between about 2% to about 6%.

However, if it is determined in step 34, that the filter cannot accommodate the treatment with the Ca/P-containing stabilizing agents, the wet cake comprising the SPLCB is fed into a reactor to be treated. The treatment step 38 is preferably conducted at a temperature between about 0° C. and about 100° C. (in some embodiments, at a temperature between about 20° C. to about 95° C.). In some embodiments, the ratio (w/w) between Ca/P-containing stabilizing agents (provided in a solution or a powder form) and the initial weight of SPLCB is between about 0.2% to about 20%, between about 0.5% to about 20%, between about 1.0% to about 20%, between about 2% to about 20% or between about 6% to about 20%. In another embodiment, the ratio (w/w) between Ca/P-containing stabilizing agents and the initial weight of SPLCB is between about 0.2% to about 12%, between about 0.5% to about 12%, between about 1.0% to about 12%, between about 2% to about 12% or between about 6% to about 12%. In still another embodiment, the ratio (w/w) between Ca/P-containing stabilizing agents and the initial weight of SPLCB is between about 0.2% to about 10%, between about 0.5% to about 10%, between about 1.0% to about 10%, between about 2% to about 10% or between about 6% to about 10%. In yet another embodiment, the ratio (w/w) between Ca/P-containing stabilizing agents and the initial weight of SPLCB is between about 0.2% to about 6%, between about 0.5% to about 6%, between about 1.0% to about 6% or between about 2% to about 6%. Once the treatment step is completed, the slurry is filtered at step 40.

When the retentate obtained after step 36 or 40 (once the treatment with the Ca/P-containing stabilizing agents is completed), it is determined, at step 42, whether a filter (for example the one used to treat the SPLCB at step 36 or to obtain the retentate after step 40) can be used to conduct a wash of the retentate with water. If a filter can be used for this washing step, the retentate is washed at step 44 directly on the filter with water. In this washing step 44, the ratio of the volume of water to the initial weight of SPLCB is at least 0.5. The washing step 44 is preferably conducted at a temperature between about 0° C. and about 100° C. (in some embodiments, at a temperature between about 20° C. to about 95° C.). An optional additional water washing step can be performed on the retentate obtained at step 38.

Alternatively, if it is determined that the filter cannot accommodate the washing step with water, the retentate obtained after step 36 or 40 is fed into a reactor to be washed, at step 46, with water. In this washing step 46, the ratio of the volume of the solution of water to the initial weight of the SPLCB is at least 0.5 so as to provide a workable slurry. The washing step 46 is preferably conducted at a temperature between about 0° C. and about 100° C. (in some embodiments, at a temperature between about 20° C. to about 95° C.). Once the water washing step is completed, the slurry is filtered at step 48. An optional additional water washing step can be performed on the retentate obtained at step 48.

The caustic leach filtrate, the treatment filtrate as well as the water wash filtrate can be mixed together or sent separately to the next stage of the process.

In some embodiments, the water washing step also comprises a pH measuring step of the washed SPLCB solid residues. This pH measurement is preferably made by diluting, with water, the SPLCB solid residue to a ratio of 1:1, a standard currently used for the pH measurements of solids. If the pH measurement indicates that the SPLCB solid residue has a pH value that would prevent it from being disposed (for example higher than 12.5), then the SPLCB solid residue is further washed to lower the pH of the SPLCB residues.

As it will be shown below, in some embodiments, it was surprisingly found that the water washing step was able to reduce the pH of the SPLCB residues after treatment with the Ca/P-containing stabilizing agent. Such reduction in pH was not observed when additives which did not contain calcium and phosphates (such as CaCl₂ or CaSO₄) were added to the treated SPLCB residues, when milk of lime treatment was substituted by a calcite treatment or when the pH of the untreated SPLCB was lowered with sulphuric acid or a solution of MgSO₄ prior to the treatment step (data not shown).

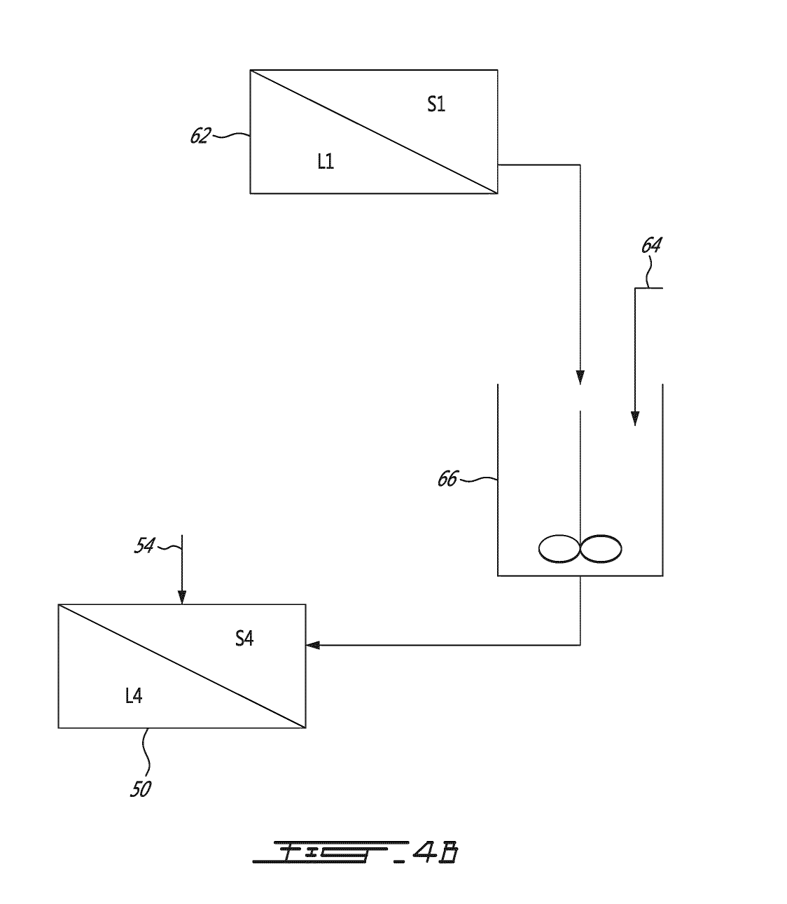

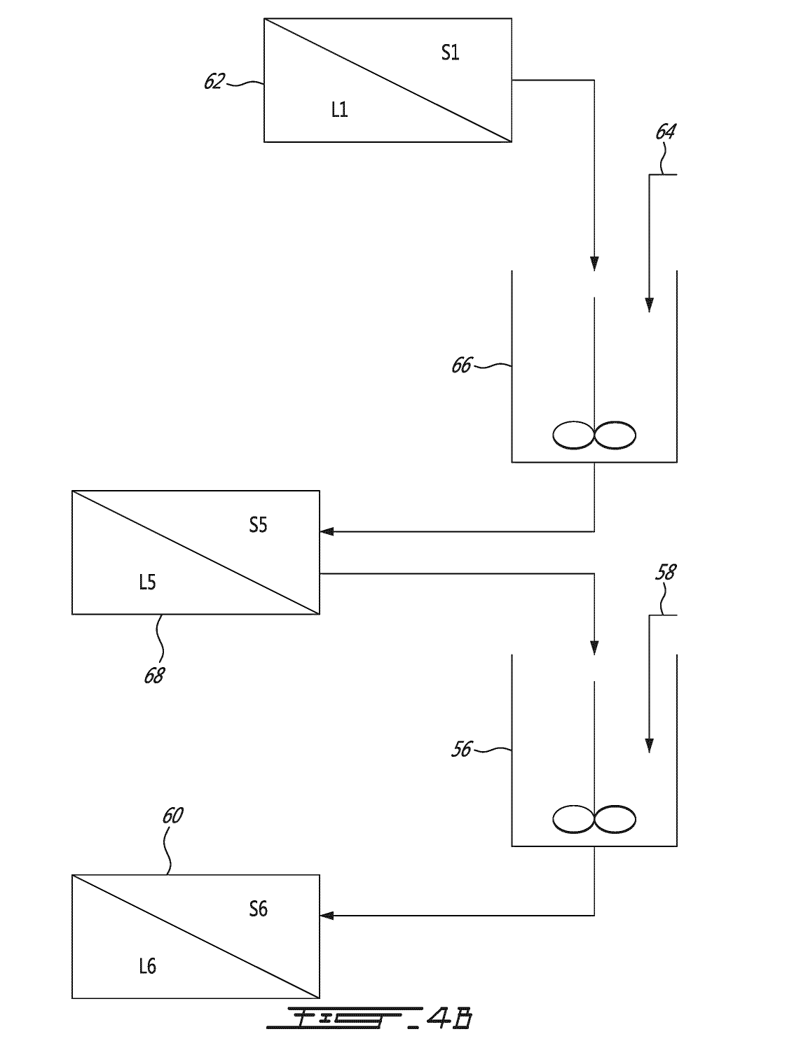

Various combinations, illustrated in FIGS. 4A to 4D, of filters and/or reactors can be used to conduct the process described herein. As shown in FIG. 4A, the treatment step as well as the washing step can be conducted serially on a filter. More specifically, the retentate S1 obtained from the caustic leaching step (for example as shown on filter 24 on FIG. 2A or 2B) can be placed on a filter 50. In this specific embodiment, it was previously determined that the filter 50 can accommodate both the treatment as well as the washing steps. First, a Ca/P-containing stabilizing agent 52 (in the form of a solution or in a powder form) is added to the retentate S1 under conditions sufficient to reduce the leachable fluorides content of the material (in some embodiments, the treatment is conducted to achieve a total leachable fluoride content ≦150 ppm). Then, water 54 is added to the treated retentate directly on the filter under conditions sufficient to reduce the pH of the retentate (in some embodiments, the retentate is washed until the material reaches a pH ≦12.50). The treatment and the washing steps can conveniently be conducted on the same filter 50 (as shown in FIG. 4A). However, in some embodiments, the treatment and the washing steps can be conducted on different filters (not shown). In such embodiment, once the treatment is completed, the retentate is placed on a second filter for the water-washing step.

As shown in FIG. 4B, the treatment step can be conducted directly on a filter whereas the washing step can be performed in a reactor. For example, the retentate S1 obtained from the caustic leaching step can be placed on a filter 51. In this specific embodiment, it was previously determined that the filter 51 can accommodate the treatment step but not the washing step. As such, Ca/P-containing stabilizing agents 52 (in the form of a solution or in a powder form) are added to the retentate S1 on filter 51 under conditions sufficient to reduce the leachable fluorides content of the material (in some embodiments, the treatment is conducted to achieve a total leachable fluoride content ≦150 ppm). Then, the wet cake is fed into a reactor 56 and admixed with water 58. The retentate can either be diluted in water prior to entering the reactor (not shown) or can be mixed with water directly into the reactor (as shown in FIG. 4B). The water washing step can be performed in baffled, stirred tanks equipped with high intensity agitation. Optionally, the tank can be equipped with a high shear mixing pump which recirculates the bottoms from each tank onto the top of the reactor. In addition, in some embodiments, the water washing step can be performed in more than one serially connected tanks. The washing step is conducted under conditions sufficient to reduce the pH of the retentate (in some embodiments, the retentate is washed until the material reaches a pH ≦12.50). After the washing step is completed, the washed slurry is filtered on filter 60 to provide a retentate S3 and a filtrate L3. Optionally, the retentate S3 can be further submitted to a water wash (not shown). The filter 60 can be the same as filter 51 or can be different.

In an alternative embodiment, the treatment step can be conducted in a reactor while the washing step can be performed on a filter. This embodiment is illustrated in FIG. 4C. For example, the retentate S1 obtained from the caustic leaching step can be placed on a filter 62. In this specific embodiment, it was previously determined that the filter 62 cannot accommodate the treatment step. As such, the wet cake is fed into a reactor 66 and admixed with Ca/P-containing stabilizing agents 64 (in liquid or solid form). The retentate can either be diluted with water and/or with a solution comprising the Ca/P-containing stabilizing agents prior to entering the reactor (not shown) or can be mixed with Ca/P-containing stabilizing agents directly into the reactor (as shown in FIG. 4C). The treatment step can be performed in baffled, stirred tanks equipped with high intensity agitation. Optionally, the tank can be equipped with a high shear mixing pump which recirculates the bottoms from each tank onto the top of the reactor. In addition, in some embodiments, the treatment step can be performed in more than one serially connected tanks. The treatment step is conducted under conditions sufficient to reduce the leachable fluorides content of the material (in some embodiments, the treatment is conducted to achieve a total leachable fluoride content ≦150 ppm of the treated material). The treated slurry is then fed to a filter 50 which has been determined to accommodate the water washing step. This filtering step provides a retentate S4 as well as a filtrate L4. Once the treated retentate S4 has been obtained, water 54 is added to the retentate on the filter to perform the wash. The washing step is conducted under conditions sufficient to reduce the pH of the retentate (in some embodiments, the retentate is washed until the material reaches a pH ≦12.50). The filter 62 can be the same as filter 50 or can be different.

In yet another embodiment, the process can be conducted with at least two reactors for providing the treatment step as well as the washing step. Such embodiment is illustrated in FIG. 4D. For example, the retentate S1 obtained from the caustic leaching step can be placed on a filter 62. In this specific embodiment, it was previously determined that the filter 62 cannot accommodate the treatment step. As such, the wet cake is fed into a reactor 66 and admixed with Ca/P-containing stabilizing agents 64 (in liquid or solid form). The retentate can either be mixed with the Ca/P-containing stabilizing agents prior to entering the reactor (not shown) or can be mixed directly into the reactor (as shown in FIG. 4D). The treatment step can be performed in baffled, stirred tanks equipped with high intensity agitation. Optionally, the tank can be equipped with a high shear mixing pump which recirculates the bottoms from each tank onto the top of the reactor. In addition, in some embodiments, the treatment step can be performed in more than one serially connected tanks. The treatment step is conducted under conditions sufficient to reduce the leachable fluorides content of the material (in some embodiments, the treatment is conducted to achieve a total leachable fluoride content ≦150 ppm of the treated material). The treated slurry is then fed to a filter 68 which has been previously determined not to accommodate the water washing step. Filter 68 provides a retentate S5 and a filtrate L5. The wet cake S5 is fed into a reactor 56 and admixed with water 58. The retentate S5 can either be diluted in water prior to entering the reactor (not shown) or can be mixed with water directly into the reactor (as shown in FIG. 4D). The water washing step can be performed in baffled, stirred tanks equipped with high intensity agitation. Optionally, the tank can be equipped with a high shear mixing pump which recirculates the bottoms from each tank onto the top of the reactor. In addition, in some embodiments, the water washing step can be performed in more than one serially connected tanks. The washing step is conducted under conditions sufficient to reduce the pH of the retentate (in some embodiments, the retentate is washed until the material reaches a pH ≦12.50). After the washing step is completed, the washed slurry is filtered on filter 60 to provide a retentate S6 and a filtrate L6. Optionally, the retentate S6 can be submitted to an additional water wash (not shown). The filters 60, 62 and 68 can be the same or can be different.

The treated SPLCB have a leachable fluoride content which is less than untreated SPLCB. In some embodiments, the leachable fluoride content of the treated SPLCB is less than 150 ppm. In addition, the optionally leached SPLCB have a pH value which less than the non-leached SPLCB. In some embodiments, the pH value of the SPLCB is less than 12.5.

The present invention will be more readily understood by referring to the following examples which are given to illustrate the invention rather than to limit its scope.

### Example I

### Milk of Lime Treatment of SPLCB

A sample of this untreated SPLCB (125 g) was diluted in water and filtered with a Bruckner filter (4″). The untreated wet cake was washed with 200 cc of milk of lime (6.6 g of hydrated lime was dissolved in 200 mL of water to generate a dosage of 4% w/w CaO/SPLCB). The pH of the solid fraction (using a 1:1 dilution) was measured for the untreated and treated SPLCB. Table A summarizes the results obtained and indicates that a milk of lime wash of an SPLCB reduces the leachable fluoride content of the material.

TABLE A
Physico-chemical characteristics of the untreated and milk
of lime-washed SPLCB.

| | Untreated | Milk of lime- |
|---|---|---|
| Characteristics | SPLCB | washed SPLCB |
| g of CA(OH)₂ to treat 125 g of SPLCB | 0 | 6.6 |
| % CaO/SPLCB | 0 | 4 |
| mean pH measurement¹ | 11.8 | 12.6 |
| mean leachable F (ppm) measurement¹ | 257 | 145 |

¹Based on three independents measurements obtained 1 day or 9 days post-treatment

### Example II

### Water Wash of Treated SPLCB

As shown in Example I, milk of lime-treated SPLCB can exhibit a pH higher than 12.5. In order to reduce the pH of milk of lime-treated SPLCB, a water wash was performed. Physico-chemical characteristics of the unwashed and washed milk of lime-treated SPLCBs were obtained.

More specifically, milk of lime-treated SPLCB were obtained. A sample of the treated SPLCB (125 g) was first mixed with 200 cc of water and then vacuum-filtered. The wet cake was further washed with 200 cc of water. The pH as well as the TCLP_{F} were measured for the unwashed and washed SPLCB. Table B summarizes the results obtained and indicates that a further water wash of a treated SPLCB reduces the pH of the material without substantially increasing the concentration of leachable fluorides.

TABLE B
pH and leachable fluoride measurement of the original
SPLCB and washed SPLCB.

| | pH of material | Leachable F (ppm) |
|---|---|---|
| Unwashed SPLCB | 13.18 | 52 |
| Water washed-SPLCB | 12.19 | 83 |

It was then determined if the pH and the TCLP_{F} characteristics of unwashed and water washed-SPLCB material are stable during storage. As such, three different samples of water washed-SPLCB were obtained and pH and the TCLP_{F} measurements have been performed after at least two months of storage. Table C summarizes the results obtained and indicates that, during storage, the pH as well as the concentration of leachable fluorides of the water washed-material do not significantly increase (a slight decrease is observed in some samples).

TABLE C
pH and leachable fluoride measurement of the original
SPLCB and washed SPLCB stored for at least two months.

| | pH of material | | | Leachable F (ppm) | | |
|---|---|---|---|---|---|---|
| | Type of treatment | | | | | |
| | Unwashed | Water-washed | | Unwashed | Water-washed | |
| | Time in storage (months) | | | | | |
| Sample | T = 0 | T = 0 | T ≧ 2 | T = 0 | T = 0 | T ≧ 2 |
| A | 12.72 | 12.54 | 12.50 | 9 | 11 | 13 |
| B | 12.78 | 12.06 | 12.09 | 19 | 55 | 77 |
| C | 12.78 | 12.13 | 12.10 | 22 | 124 | 117 |

### Example III

### Measurement of pH During the Processing of SPLCB

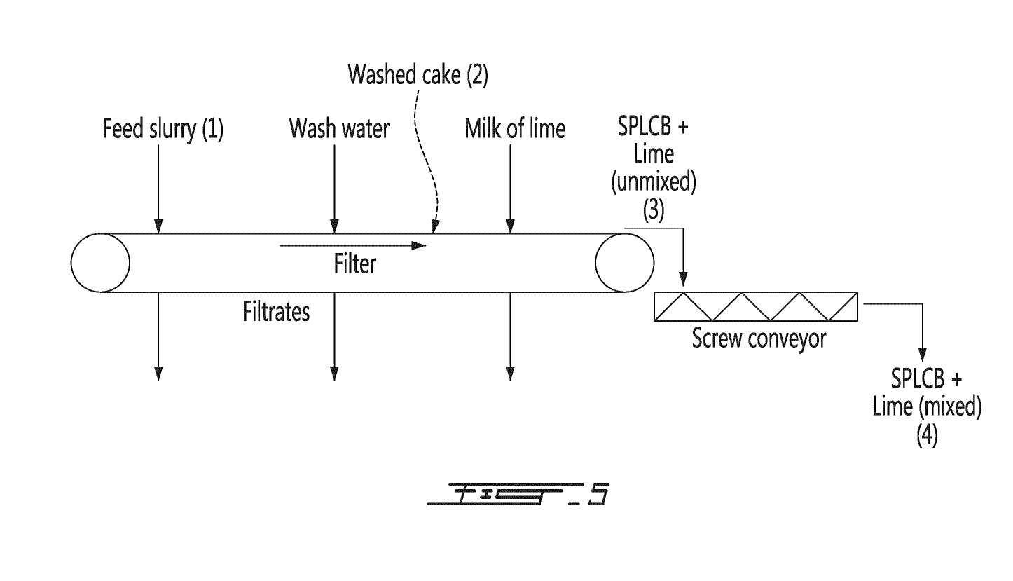

The pH of the liquor of various samples of processed SPLCB was determined at various stages as shown in FIG. 5: (1) untreated and unwashed SPLCB slurry sample, (2) water washed SPLCB retentate sample prior to the milk of lime treatment, (3) milk of lime-treated SPLCB retentate sample as well as (4) milk of lime-treated SPLCB wet cake sample after good mixing. As shown in Table D below, the milk of lime treatment increased the pH of the treated SPLCB.

TABLE D
pH measurements of various samples of processed SPLCB
as shown in FIG. 5.

| Sample ID No. | Liquor pH |
|---|---|
| 1 | 13.8 |
| 2 | 12.4 |
| 3 | 12.9 |
| 4 | 13.2 |

### Example IV

### Treatment with Ca₃(PO₄)₂

A sample of the SPLCB (125 g) was obtained and filtered. The retentate was treated with a Ca₃(PO₄)₂ solution. Five different Ca₃(PO₄)₂ solutions were prepared by neutralizing an initial H₃PO₄ solution (3, 7, 10, 25 or 50 g/L) with lime (Ca(OH₂)). pH and leachable fluoride content of the untreated and treated samples were determined. Table E summarizes the results.

TABLE E
pH and leachable fluoride measurements of SPLCB
treated with Ca₃(PO₄)₂.

| g/L of initial | Leachable F | Leachable F | |
|---|---|---|---|
| H₃PO₄ solution | (ppm) prior to | (ppm) after | pH after |
| used (85%) | treatment | treatment | treatment |
| 3 | 350 | 258 | 12.06 |
| 7 | 350 | 221 | 12.00 |
| 10 | 350 | 196 | 12.06 |
| 25 | 350 | 119 | 11.74 |
| 50 | 350 | 74 | 11.57 |

### Example IV

### Treatment with Ca₅(PO₄)₃OH or with CaHPO₄.2H₂O

A sample of an untreated SPL was obtained and was submitted to a caustic leaching in the presence or absence of Ca₅(PO₄)₃OH or CaHPO₄.2H₂O (herein referred to as the additives). The SPL (125 g) was added to a caustic leach solution (3 L of a 30 g/L of NaOH). Then, varying concentrations of Ca₅(PO₄)₃OH or CaHPO₄.2H₂O were added to the SPL/caustic leach solution. This mixture was maintained at 70° C. for 60 minutes and was then filtered. The cake was washed with water. The content of the cake was analyzed 4 days and 35 days after the caustic leach treatment. Table F summarizes the results obtained.

TABLE F
pH and leachable fluoride measurements (obtained after 4 days
or 35 days after the caustic leach) of SPLCB treated with
Ca₅(PO₄)₃OH or CaHPO₄•2H₂O during the caustic leach.

| | | | | Analyses (days post caustic leach) | | | |
|---|---|---|---|---|---|---|---|
| | | g | % (w/w) | 4 days | | 35 days | |
| | Quantity of | PO₄/kg | additive | | Leachable | | Leachable |
| Additive | additive (g) | SPL | vs. SPL | pH | F (mg/L) | pH | F (mg/L) |
| None | — | 0 | — | 12.1 | 227 | N.D. | N.D. |
| Ca₅(PO₄)₃OH | 7.5 | 34 | 6.0 | 11.9 | 39 | N.D. | N.D. |
| CaHPO₄•2H₂O | 7.5 | 34 | 6.0 | 11.8 | 79 | N.D. | N.D. |
| Ca₅(PO₄)₃OH | 15 | 67 | 12.0 | 12.0 | 3 | 12.2 | 5 |
| CaHPO₄•2H₂O | 15 | 69 | 12.0 | 11.7 | 32 | 11.9 | 46 |

A sample of an untreated SPLCB (125 g) (obtained in the absence Ca₅(PO₄)₃OH or CaHPO₄.2H₂O in the caustic leach) was diluted in water and filtered with a Bruckner filter (4″). The untreated wet cake was first washed with water and then with a solution containing Ca₅(PO₄)₃OH or CaHPO₄.2H₂O (7.5 g or 15 g of Ca₅(PO₄)₃OH or CaHPO₄.2H₂O was mixed in water to generate a dosage of 5% to 10% w/w additive/SPLCB, refer to table G). The pH of the solid fraction (using a 1:1 dilution) was measured for the untreated and treated SPLCB. Table G summarizes the results obtained.

TABLE G
pH and leachable fluoride measurements (obtained after 1, 39 or 47 days after
the washing) of SPLCB treated/washed with Ca₅(PO₄)₃OH or CaHPO₄•2H₂O.

| | | | | Analyses (days post-washing) | | | | |
|---|---|---|---|---|---|---|---|---|
| | Additive | | | 1 day | | 39 days | | 47 days |
| Cake | | | % (w/w) | | Leachable | | Leachable | Leachable |
| weight (g) | Type | g | (vs SPLCB) | pH | F (ppm) | pH | F (ppm) | F (ppm) |
| 130 | None | — | — | 11.8 | 288 | 12.0 | 304 | 307 |
| 146 | Ca₅(PO₄)₃OH | 7.5 | 5.1 | 11.8 | 125 | 12.2 | 218 | 217 |
| 151 | CaHPO₄•2H₂O | 7.5 | 5.0 | 9.0 | 91 | 9.8 | 90 | 84 |
| 153 | Ca₅(PO₄)₃OH | 15.0 | 9.8 | 11.7 | 7 | 12.1 | 168 | 166 |
| 162 | CaHPO₄•2H₂O | 15.0 | 9.3 | 7.9 | 17 | 8.8 | 19 | 17 |

A sample of an untreated SPLCB (125 g) (obtained in the absence Ca₅(PO₄)₃OH or CaHPO₄.2H₂O in the caustic leach) was diluted in water and filtered with a Bruckner filter (4″). The untreated wet cake was washed twice with water. Then, crushed Ca₅(PO₄)₃OH or CaHPO₄.2H₂O was added to the washed cake to generate a dosage of 5% w/w additive/SPLCB (refer to table H). The pH of the solid fraction (using a 1:1 dilution) was measured for the untreated and treated SPLCB. Table H summarizes the results obtained.

TABLE H
pH and leachable fluoride measurements of SPLCB's cake
treated with Ca₅(PO₄)₃OH or CaHPO₄•2H₂O.

| | |
|---|---|
| Additive | Analyses |

| % | Type | pH | Leachable F (ppm) |
|---|---|---|---|
| — | None | 11.7 | 335 |
| 5 | Uncrushed Ca₅(PO₄)₃OH | 11.8 | 223 |
| 5 | Uncrushed CaHPO₄•2H₂O | 9.5 | 104 |
| 5 | Crushed Ca₅(PO₄)₃OH | 11.9 | 59 |
| 5 | Crushed CaHPO₄•2H₂O | 9.3 | 88 |

While the invention has been described in connection with specific embodiments thereof, it will be understood that the scope of the claims should not be limited by the preferred embodiments set forth in the examples, but should be given the broadest interpretation consistent with the description as a whole.

1. A process for treating spent pot lining carbon by-products (SPLCB), said process comprising treating, during a caustic leach, a spent pot lining (SPL) with Ca/P-containing stabilizing agents and/or treating, during a wash, a SPLCB with Ca/P-containing stabilizing agents to obtain SPLCB residues.

2. The process of claim 1, wherein the ratio (w/w) between Ca/P-containing stabilizing agents and the initial weight of the SPL or the SPLCB is between about 0.2% w/w to about 20% w/w.

3. The process of claim 1, wherein the Ca/P-containing stabilizing agents comprises a calcium phosphate.

4. The process of claim 3, wherein the calcium phosphate is selected from the group consisting of Ca₃(PO₄)₂, Ca(HPO₄), Ca(H₂PO₄)₂, Ca₂O₇P₂, Ca₅(PO₄)₃OH, Ca(HPO₃), Ca(PO₃)₂, Ca(H₂PO₂)₂, Ca₅(PO₄)₃OH), their hydrated forms and combinations thereof.

5. The process of claim 1, wherein the Ca/P-containing stabilizing agents comprises a lime and phosphoric acid.

6. The process of claim 5, wherein the lime is a milk of lime.

7. The process of claim 1, wherein at least one of the treatment step is conducted on a filter.

8. The process of claim 7, wherein the filter is a treatment filter or a washing filter.

9. The process of claim 1, wherein at least one of the treatment step is conduction in a reactor.

10. The process of claim 9, wherein the reactor is a treatment reactor or a washing reactor.

11. The process of claim 1, wherein the process excludes the use of a surfactant.
